(19) United States
(12) Patent Application Publication
(10) Pub. No.: US 2013/0299257 A1
(43) Pub. Date: Nov. 14, 2013

(54) BATTERY HOUSING

(71) Applicant: MAGNA STEYR FAHRZEUGTECHNIK AG & CO KG, Graz (AT)

(72) Inventors: Manuel ERLACHER, Radenthein (AT); Reinhard HÖRMANN, Hitzendorf (AT); Martin RODLER, Krottendorf (AT); Harald ZACHNEGGER, Graz (AT)

(73) Assignee: MAGNA STEYR Fahrzeugtechnik AG & Co KG, Graz (AT)

(21) Appl. No.: 13/889,624

(22) Filed: May 8, 2013

(30) Foreign Application Priority Data
May 8, 2012 (EP) 12167123.4

(51) Int. Cl. B60K 1/04

(52) U.S. Cl. CPC B60K 1/04
USPC 180/68.5; 29/623.1

(57) ABSTRACT

A battery housing configured to receive inner portions of a vehicle battery and which is configured to have a at least one vehicle seat directly mounted thereon and/or thereover.

### CROSS-REFERENCE TO RELATED APPLICATIONS

The present application claims priority under 35 U.S.C. §119 to European Patent Application No. 12 167 123.4 (filed on May 8, 2012), which is hereby incorporated by reference in its entirety.

### TECHNICAL FIELD

Embodiments are directed to a housing configured to receive inner portions of a vehicle battery, the housing being intended for assembly in a vehicle.

Embodiments are also directed to a housing having a seat rail and a vehicle battery having a vehicle seat.

Embodiments are further directed to a method for assembling a vehicle battery having a vehicle seat in a vehicle.

### BACKGROUND

Such battery housings are used in particular for high-voltage batteries, which are used as drive batteries for electric and hybrid vehicles. High-voltage batteries generally have relatively large dimensions in order to meet the required power demands, so that an optimal arrangement of the battery with the battery housing thereof in a vehicle is significant.

German Patent Publication No. DE 41 29 737 A1 discloses an electrically driven vehicle in which the battery is arranged upstream of the rear axle. The battery is surrounded by a peripheral carrier structure. A base plate and a cover are secured to the carrier structure. A rear seat or a rear seat bench may be arranged on the cover.

German Patent Publication No. DE 10 2011 102 019 A1 discloses a battery assembly structure for an electric motor vehicle. A battery unit, comprising a plurality of battery modules and battery assembly portions is arranged so as to be covered by covering members and below a vehicle base. A rear seat is arranged on a rear base portion of the vehicle base.

Although the vehicle batteries mentioned are arranged in a relatively space-saving manner partially below vehicle seats, their integration in the vehicle structure is slight.

### SUMMARY

Embodiments are directed to an enhanced housings of the type, and in particular, enhanced housings for a vehicle battery configured for integration in a vehicle in an optimum manner.

Embodiments are directed to a method for assembling a vehicle battery in a vehicle, in accordance with embodiments.

In accordance with embodiments, a housing is configured to receive inner portions of a vehicle battery, and for assembly in vehicle, and at least one of an element, system, device or mechanism configured to secure, attach, mount or connect at least one vehicle seat formed on and/or over the housing.

In accordance with embodiments, the housing of a vehicle battery is constructed in such a manner that at least one vehicle seat may be secured, attached, mounted or connected directly to the housing.

In accordance with embodiments, in addition to the function as a housing for the vehicle battery, the housing also acts as a carrying element of the vehicle structure, in which it, at the same time, allows at least one vehicle seat to be secured, attached, mounted or connected thereto.

In accordance with embodiments, the housing accommodates the inner portions of a vehicle battery, such as for example, battery cells, cooling/heating elements for the battery cells, prefabricated battery modules and/or at least one battery control device.

In accordance with embodiments, the housing is constructed in such a manner to be suitable for reliably receiving the inner portions of the battery in the operating state thereof, and if necessary, makes provision for connections of the battery to be guided in an outward direction.

In accordance with embodiments, the housing may form together with its inner portions a drive battery of an electric or hybrid vehicle.

In accordance with embodiments, seat rails may preferably be secured to the housing. The housing is therefore prepared for seat rails to be assembled directly on the housing of the vehicle battery in order to support at least one vehicle seat. Screwing locations for securing the seat rails are preferably formed on the battery housing.

In accordance with embodiments, a plurality of vehicle seats, in particular all the seats and optionally seat benches of the vehicle, may be secured, attached, mounted or connected to the housing.

In accordance with embodiments, safety belt connections are configured to be secured to the housing. In addition to receiving at least one vehicle seat, at least one connection of the safety belt for this seat, in particular at least one belt lock and/or an end fitting for a safety belt, can also be secured to the housing.

In accordance with embodiments, screwing locations are configured to secure the safety belt connections and may be preferably formed on and/or over the battery housing.

In accordance with embodiments, at least one recess for at least one foot space of an occupant of the vehicle is constructed at the upper side of the housing in the installation position. Therefore, the upper side has one or more recesses which serve to expand the foot space for the passengers of the vehicle.

In accordance with embodiments, at least one side wall of the housing has a reinforcement. The reinforcement is preferably constructed in such a manner that the reinforced side wall of the housing not only protects the battery, but additionally protects the inner space of the vehicle in the event of accidents, and therefore, acts as a measure to reduce the risk in the event of a side-impact crash.

In accordance with embodiments, the reinforcement of the housing is preferably constructed as a honeycomb structure. The wall of the housing itself may, for example, be constructed as a honeycomb structure or also be reinforced by an additional reinforcement plate having a honeycomb structure.

In accordance with embodiments, a housing for a vehicle battery may include at least one of the following: at least one seat rail, the at least one seat rail configured to be secured to the housing.

In accordance with embodiments, a vehicle battery may include at least one of the following: a housing having at least one vehicle seat, the at least one vehicle seat being secured to the housing. The vehicle seat is generally indirectly secured to the battery housing, in particular by way of seat rails.

In accordance with embodiments, a method for assembling a vehicle battery having at least one vehicle seat in a vehicle includes at least one of the following: securing a vehicle battery via a battery housing to the at least one vehicle seat; arranging the secured vehicle battery and at least one vehicle seat into the bodywork of the vehicle; and securing the battery housing to the vehicle. The unit comprising the vehicle battery and the vehicle seat or vehicle seats is preferably pushed into the vehicle from spatially beneath the bodywork of the vehicle.

### DRAWINGS

Embodiments are described by way of example below with reference to the drawings.

FIGS. 1A and 1B are schematic illustrations from a side view and a top view, respectively, of a battery housing in accordance with embodiments.

### DESCRIPTION

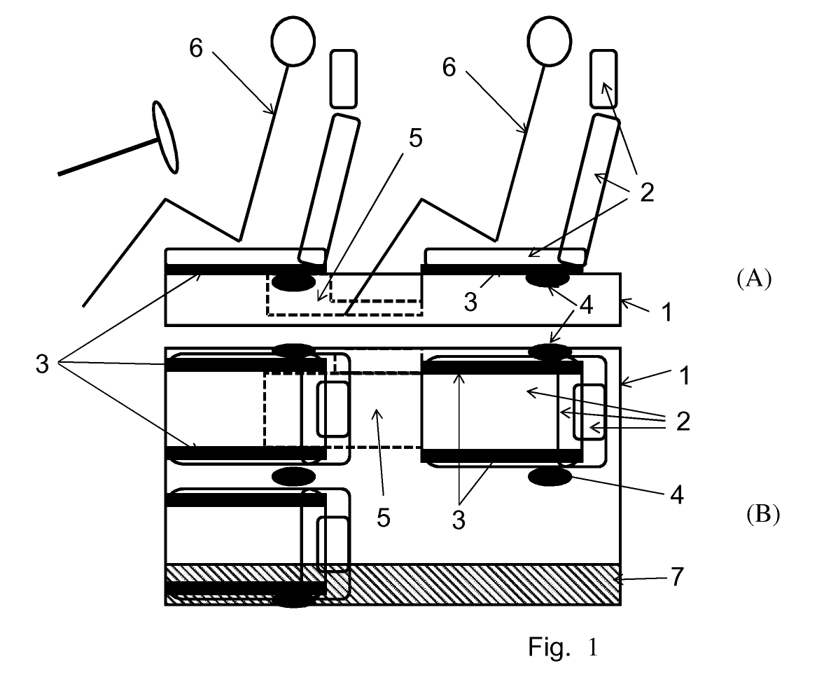

FIGS. 1A and 1B illustrate a battery housing 1 in accordance with embodiments on and/or over which seat rails 3 for a plurality of vehicle seats 2 are directly secured, attached, connected or mounted. Such direct securing, attachment, connection or mounting may be effectuated mechanically.

FIG. 1B illustrates two front and one rear vehicle seat 2, with a pair of seat rails 3 thereof in which each vehicle seat 2 is guided for movement and with corresponding safety belt connections 4, respectively. The safety belt connections 4 are in particular belt locks and/or end fittings. In order to expand the foot space for a rear passenger, illustrated by the rear occupant 6, a recess 5 is provided in the battery housing 1. The recess 5 is constructed to have an area sufficient for relevant expansion of the foot space of the rear occupant 6 to be produced.

As illustrated in FIG. 1B, the battery housing 1 is provided on a side wall with a reinforcement 7 which extends over the entire surface of the battery housing 1.

Embodiments consequently enable optimal integration of a battery housing in a vehicle.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A battery housing, comprising:
a battery housing base configured to receive inner components of a vehicle battery; and
a device configured to mount at least one vehicle seat to the battery housing base.

2. The battery housing of claim 1, wherein the at least one vehicle seat is mounted to the battery housing base via seat rails.

3. The battery housing of claim 2, wherein the battery housing base has screwing locations configured to permit securing of the battery housing base to the seat rails.

4. The battery housing of claim 1, wherein the battery housing base is configured to be secured to a safety belt connection of the at least one vehicle seat.

5. The battery housing of claim 4, wherein the battery housing base has screwing locations configured to permit securing of the battery housing base to the safety belt connection.

6. The battery housing of claim 1, wherein an upper side of the battery housing base has at least one recess configured to permit at least one foot space of an occupant of the vehicle.

7. The battery housing of claim 1, wherein at least one side wall of the battery housing base has a reinforcement.

8. The battery housing of claim 7, wherein the reinforcement is constructed as a honeycomb structure.

9. A vehicle battery, comprising:
a battery housing configured to receive inner components of the vehicle battery and also configured to having at least one vehicle seat; and
a device configured to mount the at least one vehicle seat to the battery housing.

10. The vehicle battery of claim 9, wherein the at least one vehicle seat is mounted to the battery housing base via seat rails.

11. The vehicle battery of claim 10, wherein the battery housing base has screwing locations configured to permit securing of the battery housing base to the seat rails.

12. The vehicle battery of claim 9, wherein the battery housing base is configured to be secured to a safety belt connection of the at least one vehicle seat.

13. The vehicle battery of claim 12, wherein the battery housing base has screwing locations configured to permit securing of the battery housing base to the safety belt connection.

14. The vehicle battery of claim 9, wherein an upper side of the battery housing base has at least one recess configured to permit at least one foot space of an occupant of the vehicle.

15. The vehicle battery of claim 9, wherein at least one side wall of the battery housing base has a reinforcement.

16. The vehicle battery of claim 15, wherein the reinforcement is constructed as a honeycomb structure.

17. A method, comprising:
mounting at least one vehicle seat to a vehicle battery;
arranging the mounted at least one vehicle seat with the vehicle battery into a bodywork of a vehicle.

18. The method of claim 17, further comprising securing the mounted at least one vehicle seat with the vehicle battery to the vehicle.
